(19) United States
(12) Patent Application Publication
(10) Pub. No.: US 2006/0208893 A1
(43) Pub. Date: Sep. 21, 2006

(54) Weight audit methods and systems utilizing data reader

(76) Inventors: Gary Steven Anson, Cheshire, OR (US); Clarke William McAllister, Eugene, OR (US)

Correspondence Address: STOEL RIVES LLP, 900 SW FIFTH AVENUE, SUITE 2600, PORTLAND, OR, 97204-1268, US

(21) Appl. No.: 11/364,851

(22) Filed: Feb. 27, 2006

Related U.S. Application Data
(60) Provisional application No. 60/714,543, filed on Feb. 28, 2005.

(51) Int. Cl. G08B 13/14; G06F 7/00; G06F 17/00; G08B 21/00

(52) U.S. Cl. 340/572.1; 340/572.8; 235/375; 700/215; 340/666; 700/217

(57) ABSTRACT

A device, which may be mobile, comprises a data reader, scale, alarm indicator, and processor. The reader is capable of reading data encoded on an item within a reading zone, thereby generating read data. The item may be a pallet loaded with bulk articles. The device, if mobile, is positionable such that the item is within the reading zone and on the scale. The scale generates measured weight data of an item placed on the scale. The processor, which is connected to the reader, scale, and alarm indicator, is configured to access the read data and the measured weight data, to determine based on the read data an expected weight of the item, to compare the expected weight and the measured weight data, and to conditionally activate the alarm indicator if the expected weight and the measured weight data differ by at least a threshold amount.

### RELATED APPLICATIONS

This application claims priority to U.S. Patent Application No. 60/714,543, entitled “RFID Weight Audit,” filed on Feb. 28, 2005, which is hereby incorporated by reference in its entirety.

### TECHNICAL FIELD

This disclosure relates generally but not exclusively to data readers such as optical code readers or RFID (radio frequency identification) readers, and more particularly, to object tracking using data readers.

### BACKGROUND INFORMATION

An RFID system typically employs at least two components: a “transponder” or “tag,” which is attached to the physical item to be identified, and an “interrogator” or “reader,” which sends an electromagnetic signal to the transponder and then detects a response. A typical tag stores useful information such as an identification code for the item to which it is attached. A typical reader emits an RF (radio frequency) signal that is received by the tag after the tag comes within an appropriate range. In response to the signal from the reader, the tag sends back to the reader a modulated RF signal containing the tag's information. The reader detects this modulated signal and can identify the tag by demodulating and decoding the received signal. After identifying the tag, the reader can either store the decoded information or transmit the decoded signal to a computer.

The tag used in an RFID system may be either “passive” or “active.” A passive tag can be a simple resonant circuit, including an inductive coil and a capacitor. Passive tags are generally powered by the carrier signal transmitted from the reader. Active tags, on the other hand, generally include transistors or other active circuitry, and require their own battery source. Moreover, a tag's memory may be writable, and an RFID reader may transmit data to an RFID tag to overwrite the tag's memory.

### SUMMARY OF THE DISCLOSURE

According to one embodiment, a method reads data encoded on a pallet loaded with bulk articles and determines, based on the data, an expected weight of the pallet and bulk articles. The method weighs the pallet and bulk articles, thereby generating a measured weight, and compares the expected weight and the measured weight. The method conditionally issues a signal if the expected weight and the measured weight differ by at least a threshold amount.

According to another embodiment, a method moves a data reader within a reading range of a container loaded with articles, reads data encoded on the container by use of the data reader, and determines, based on the data, an expected weight of the container and articles. The method moves a scale underneath the container, weighs, by use of the scale, the container and bulk articles, thereby generating a measured weight, and compares the expected weight and the measured weight. The method conditionally issues a signal if the expected weight and the measured weight differ by at least a threshold amount.

According to another embodiment, a mobile device comprises a data reader, a scale, an indicator, and a processor. The data reader is capable of reading data encoded on an item within a reading zone, thereby generating read data, wherein the mobile device is positionable such that the item is within the reading zone. The scale generates measured weight data of an item placed on the scale, wherein the mobile device is positionable such that the item is on the scale. The processor, which is connected to the data reader, the scale, and the indicator, is configured to access the read data and the measured weight data, to determine based on the read data an expected weight of the item, to compare the expected weight and the measured weight data, and to conditionally activate the indicator if the expected weight and the measured weight data differ by at least a threshold amount.

According to yet another embodiment, a device comprises a data reader, a scale, an indicator, and a processor. The data reader is capable of reading within a reading zone data encoded on a pallet loaded with bulk articles, thereby generating read data. The scale generates measured weight data of the pallet and any items loaded on the pallet when the pallet is placed on the scale. The processor, which is connected to the data reader, the scale, and the indicator, is configured to access the read data and the measured weight data, to determine based on the read data an expected weight of the pallet and its loaded items, to compare the expected weight and the measured weight data, and to conditionally activate the indicator if the expected weight and the measured weight data differ by at least a threshold amount.

Details concerning the construction and operation of particular embodiments are set forth in the following sections with reference to the below-listed drawings.

### BRIEF DESCRIPTION OF THE DRAWINGS

FIG. 1 is a drawing of a forklift, according to one embodiment.

FIG. 2 is a drawing of a pallet, according to one embodiment.

FIG. 3 is a block diagram of a system according to one embodiment.

FIG. 4 is a block diagram of a system according to another embodiment.

FIG. 5 is a diagram depicting a sequence of steps in the handling of the pallet of FIG. 2, according to one embodiment.

FIG. 6 is a flowchart of a method according to one embodiment.

### DETAILED DESCRIPTION OF EMBODIMENTS

With reference to the above-listed drawings, this section describes particular embodiments and their detailed construction and operation. The embodiments described herein are set forth by way of illustration only. Those skilled in the art will recognize in light of the teachings herein that variations can be made to the embodiments described herein and that other embodiments are possible. No attempt is made to exhaustively catalog all possible embodiments and all possible variations of the described embodiments.

For the sake of clarity and conciseness, certain details of components or steps of certain embodiments are presented without undue detail where such detail would be apparent to those skilled in the art in light of the teachings herein and/or where such detail would obfuscate an understanding of more pertinent aspects of the embodiments.

As one skilled in the art will appreciate in view of the teachings herein, certain embodiments may be capable of achieving certain advantages, including by way of example and not limitation one or more of the following: (1) better tracking of items; (2) earlier detection of error conditions in item handling; (3) labor saving by, for example, facilitating weighing, data reading, and audit operations during normal item handling and transport operations; and (4) deterrence of theft and encouragement of more careful item handling. These and other advantages of various embodiments will be apparent upon reading the following.

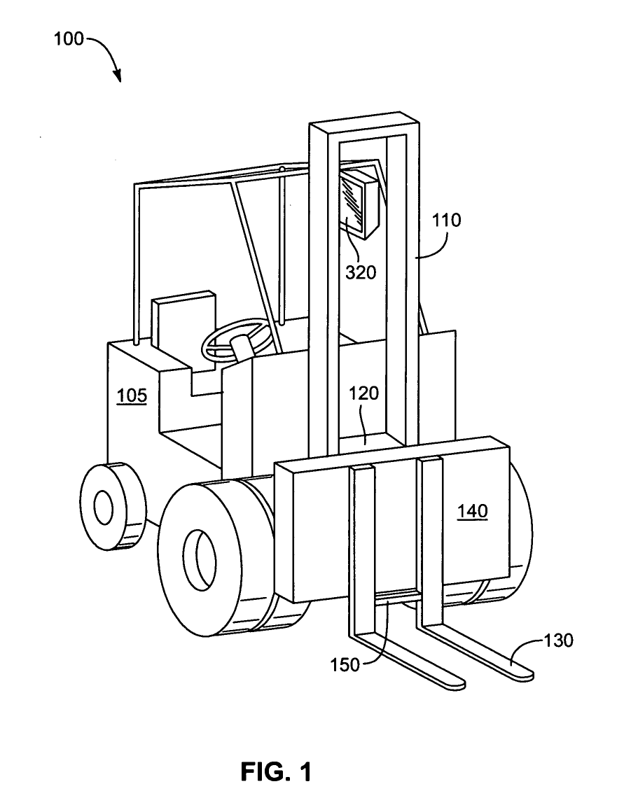

FIG. 1 is depicts a forklift 100, according to one embodiment. The forklift 100 is useful to lift and transport heavy items, such as a pallet loaded with bulk (i.e., heavy or numerous or both) items. The forklift 100 comprises a cab section 105 and a mast 110. A movable element 120 moves vertically in the middle of the mast 110. Attached to the movable element 120 are two forks 130.

Between the moveable element 120 and the forks 130 is a scale 140, which can weigh a pallet, container, or other load on the forks 130. For example, the scale 140 may be a forklift truck scale manufactured by Avery Weigh-Tronix, LLC, Fairmont, Minn., such as its model QTLTSC scale.

The forklift 100 is also equipped with a data reader 150, which is preferably an RFID reader but may be a data reader of any type, such as an optical code reader (e.g., bar code). The data reader 150 is preferably positioned on the front of the forklift 100 facing forward to enable it to read data from a pallet, container, load, or other item on the forks 130. For reading pallets, the data reader 150 is preferably positioned low, such as below the movable element 120 and/or the scale 140.

The data reader 150 is electrically connected to a computer or other data processor (not shown) on the forklift 100 or a remote computer. Alternatively, the computer may be integrated within the data reader 150. The computer may display data on an electronic display 320 and/or may communicate the data wirelessly to another computer, such as a central computer in a warehouse, store, or other setting in which the forklift 100 operates.

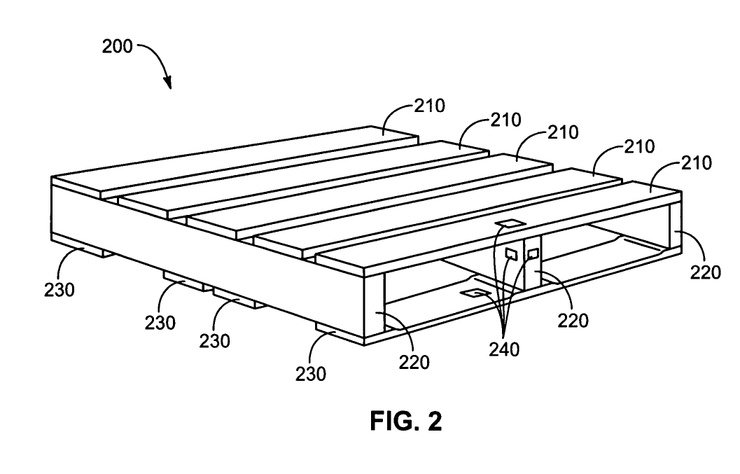

FIG. 2 depicts a pallet 200, according to one embodiment. The pallet 200 comprises a number of top boards 210, support members 220, and bottom boards 230. The support members 220 are spaced apart such that the forks 230 of the forklift 200 fit between the support members 220 to lift the pallet 200 and its contents or load.

The pallet 200 also has placed on it a tag 240, such as a code or identification tag, which is preferably placed on or near a side or sides of the pallet 200 that is faced by the forklift 100 during a lifting operation. FIG. 2 shows several alternative locations for the tag 240, which may be placed on the top or bottom of a top or bottom board 210 or 230, or the end or either side of a support member 220, for example. Depending on the range and spatial constraints of the data reader, proximity of the tag 240 to the data reader may be more or less important. When the tag 240 is an optical code, and the data reader is an optical code reader, then close proximity and a facing orientation of the tag 240 toward the reader is important. For an RFID reader, depending on its reading range and orientation or polarization sensitivity, any RFID tag 240 placed anywhere on the pallet 200 may be acceptable. Nonetheless, there is typically some benefit in terms of signal strength and thus reading reliability to have the tag 240 well placed for optimum reading.

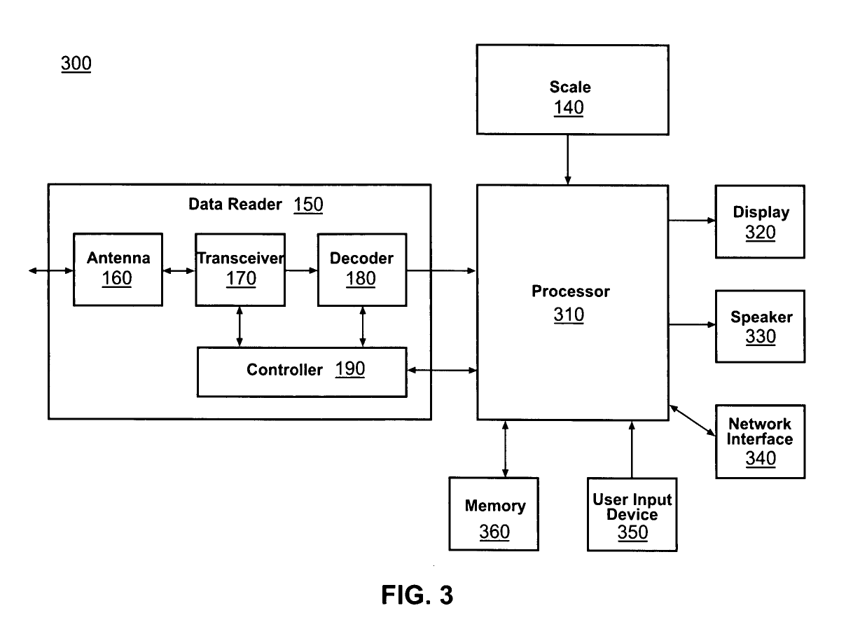

FIG. 3 is a functional block diagram of a system 300 according to one embodiment. The system 300 comprises a scale 140, a data reader 150, a processor 310, and a number of other components connected to the processor 310. One embodiment of the scale 1.40 was described above as part of the forklift 100 (FIG. 1). Alternatively, the scale 140 may be a generally fixed, non-mobile floor scale, or any other type of scale or weighing means. The scale 140 generates an electrical signal that represents the weight or mass of an object or set of objects.

The data reader 150 in this embodiment is an RFID reader comprising an antenna 160, a transceiver 170, a decoder 180, and a controller 190. The antenna 160 may be any suitable antenna that can transmit and receive electromagnetic signals within a reading volume. Typical RFID systems operate in the following frequency bands: 125-134 kHz (kiloHertz or thousands of cycles per second), 13.56 MHz (megaHertz or millions of cycles per second), UHF (ultra high frequency) (400-930 MHz), 2.45 GHz (gigaHertz or billions or cycles per second), and 5.8 GHz. The antenna 160 is typically chosen for a desired performance in one or more of those bands. The transceiver 170 generates an activation/interrogation signal and receives response(s) from one or more RFID tags. The transceiver 170 typically includes a modulator, filter(s), and amplifiers for transmission, as well as an amplifier, demodulator and filter(s) for reception. The transceiver 170 also typically includes a frequency synthesizer or RF oscillator shared by both the transmission and reception circuitry. This data reader 150 also comprises a decoder 180, which decodes a demodulated signal supplied from the transceiver 170 to determine the data transmitted by the RFID tag(s). Alternatively, the function of the decoder 180 may be incorporated within the processor 310 rather than as part of the data reader 150. This data reader 150 also comprises a controller 190 that controls the operation of the transceiver 170 and the decoder 180. The controller 190 also provides an interface to the processor 310 from the data reader 150 for setup, status, command, control, and the like. The data reader 150 or just the antenna 160 may be mobile, removable, handheld, tethered by an electrical cable, etc.

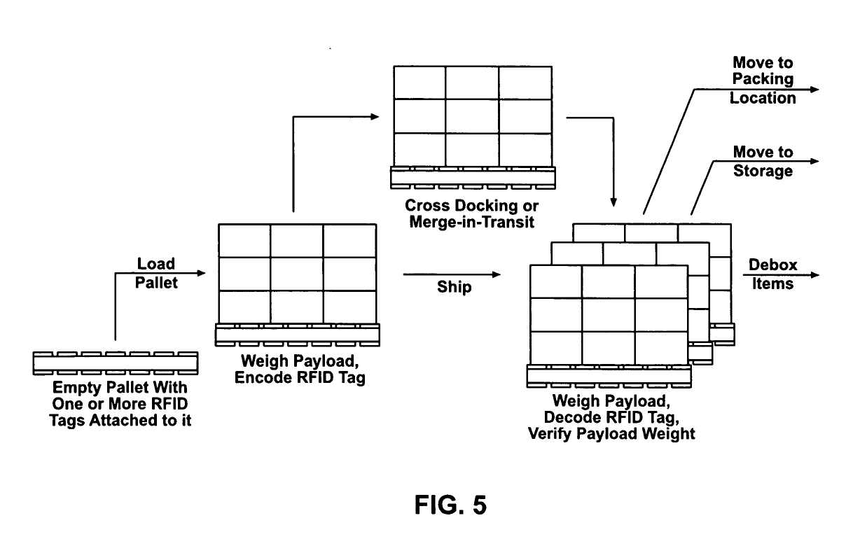

The processor 310 may be any form of processor and is preferably a digital processor, such as a general-purpose microprocessor or a digital signal processor (DSP), for example. The processor 310 may be readily programmable; hard-wired, such as an application specific integrated circuit (ASIC); or programmable under special circumstances, such as a programmable logic array (PLA) or field programmable gate array (FPGA), for example. Program memory for the processor 310 may be integrated within the processor 310, permanently connected separately from the processor 310, or externally removable. The processor 310 executes one or more programs to control the operation of the other components, to transfer data between the other components, to associate data from the various components together (preferably in a suitable data structure), to perform calculations using the data, to otherwise manipulate the data, and to present results and significant conditions to the user or to other equipment. For example, the processor 310 preferably determines an expected weight for an item or set of items based on the data read from one or more RFID tags associated with the item or set of items, compares that expected weight to the weight as measured by the scale 140, and issues a signal (e.g., raises an alarm) or takes other actions based on that comparison, as described in greater detail below with reference to the flowchart shown in FIG. 5.

Connected to the processor 310 are a display 320, a speaker 330, a network interface 340, a user input device 350, and a memory 360. The display 320 may display such information as measured weight; data, such as identification data, read from the RFID tag(s), alarm conditions, such as when the measured weight does not match the expected weight for the item; pickup and drop-off instructions, and any variety of status information. The speaker 330 may be activated to audibly alert the user or other persons of an alarm condition or for other purposes.

The network interface 340 may be a plug-in port or a wireless communications point. In one preferred embodiment, the network interface is a wireless network interface operating in accordance with a standard wireless network protocol such as the Institute of Electrical and Electronics Engineers (IEEE) 802 standards (e.g., IEEE 802.11 standard for wireless local area networks (WLAN)). In one embodiment, the processor 310 accesses expected weight data stored on another computer, such as a central computer, for comparison with the weight measured by the scale 140, via the network interface 340. The processor 310 may also send measured weight data, data read by the data reader 150, and/or alarm conditions to another computer via the network interface 340.

The user input device 350 may be any device used by a user to input data or commands to the processor 310. Examples of the user input device 350 include keypads, keyboards, pointing devices (e.g., mouse, joystick, trackball), buttons, and a touch screen. The memory 360 may store programs executed by the processor 410, expected weight data for a set of items, and/or other data. The memory 360 may be permanent or removable.

As an alternative to what is illustrated in FIG. 3, the data reader 150 may operate according to another principle different from RFID. For example, the data reader 150 may be an optical code reader that reads information encoded on an optical code on the item or set of items placed on or near the scale 140. The most common example of an optical code is a bar code; thus, according to one embodiment, the tag 240 on the pallet 200 or on the items on the pallet 240 is a bar code, and the data reader 150 is a bar code reader.

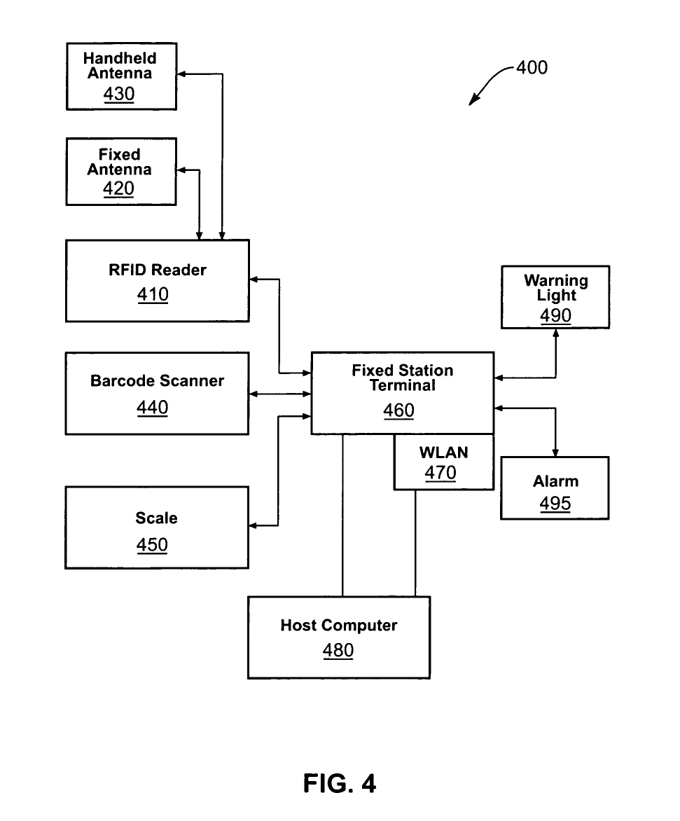

As yet another alternative, the system 300 may comprise multiple different types of data readers, such as a combined RFID reader and bar code reader. Such a multiple-technology reader is described, for example, in U.S. Pat. No. 6,415,978, entitled “Multiple Technology Data Reader for Bar Code Labels and RFID Tags,” which is incorporated herein by reference. One example of a multiple-technology reader for use in a weight-audit system is illustrated in FIG. 4. In that figure, the weight-audit system 400 is a movable system (preferably configured on a forklift, such as the forklift 100 (FIG. 1) or other mobile item-handling device) for tracking inventory movable to a plurality of locations. The system 400 includes an RFID reader 410 having both a fixed antenna 420 and a portable handheld antenna 430. The combination of the RFID reader 410 and one of the antennas 420 or 430 is similar to the data reader 150 shown in FIG. 3. An advantage of the dual-antenna design is that the fixed antenna 420 requires less manual intervention in most situations, especially when the RFID tags are well placed to facilitate reading by the fixed antenna 420, whereas the handheld antenna 430 provides flexibility for the user to position that antenna to read otherwise hard-to-read places for tags. In addition, the system 400 comprises a portable handheld barcode scanner 440, which may be fixed or handheld. Although RFID has some advantages over bar codes in many settings (e.g., “facing” of the reader to the tag may not be require or may be less demanding; the requirements or distance, speed, direction and orientation are generally relaxed; multi-tag reading can be more efficient; and the storage capabilities of RFID tags can be taken advantage of), flexibility, economy, and speed of deployment can be enhanced by providing the capability to work with bar codes. A scale 450 may be any weighing means but is preferably a commercial legal-for-trade scale or electronic load-cell, of which many are known in the pallet-weighing and related arts. A fixed station terminal 460 is also part of the weight-audit system 400. The fixed station terminal 460 is a computer comprising, for example, the processor 310 and associated peripherals as shown in FIG. 3. The fixed station terminal 460 is a portable computer that may be ruggedized for use in an industrial or warehouse setting. Connected to the fixed station terminal 460 is a WLAN adaptor 470 to enable wireless communication. The fixed station terminal 410 interfaces with a host computer 480 either by cable plug-in or wirelessly via the WLAN adaptor 470. Finally, the system 400 comprises a warning light 490 and/or an alarm 495 to alert a user of missing inventory items from a pallet or defective RFID tag(s) on an RFID-tagged pallet.

FIG. 5 is a set of drawings pictorially depicting a sequence of steps in the handling of the pallet 200, according to one embodiment. More specifically, FIG. 5 depicts an RFID-based weight audit in a supply-chain application to track inventory at a plurality of locations. The sequence of events in this audit is depicted from left to right in the drawing. To begin, a user locates at an origination location an empty pallet 200, which may have one or more RFID tags 240 attached to it, and loads the pallet 200 at the origination location with inventory items to provide a loaded pallet. The audit then proceeds using a first vehicle movable to a number of pallet origination locations. The first vehicle may be the fork lift 100, a lift truck, a pallet truck, a cart or any material handling device. The first vehicle includes a scale and an RFID reader, etc., as depicted for example in FIGS. 3 or 4. (Hereafter the reference numbers appearing in FIG. 1-3 will be used for the sake of concreteness.) The RFID reader 150 sends and receives RF signals to/from RFID tags 240 located on the pallet 200 and/or the inventory items positioned on the pallet 200. The user next weighs the loaded pallet 200 and encodes that weight information on the RFID tag 240 that is to be attached to the loaded pallet or already attached to the loaded pallet. That is preferably accomplished by the user reading the pallet weight from the scale 140 and encoding and writing that weight information on the RFID tag 240 by using the RFID reader 150. The loaded pallet 200 of inventory items is then shipped to one of a plurality of destination locations. At intermediary steps, the loaded pallet 200 may be moved at the origination location before shipping or during shipping merged-in transit with other pallets. At any intermediary step or when the loaded pallet 200 reaches a destination location, a second vehicle movable to a plurality of destination locations and including a scale 140, an RFID reader 150, and other equipment interrogates the RFID tags 240 located on the pallets 200 and/or the inventory items positioned on the pallet 200 and weighs the items. For example, at the destination location the received pallet 200 is weighed and interrogated using the second vehicle. If the weight of the pallet 200 of inventory items has changed, then a warning light, flashing display, and/or an audible alarm can be activated to indicate to the user there is a problem. The user can then undertake an appropriate business strategy to deal with the problem. In due course, the pallet 200 cam be moved to a pickup location or a storage location, the items can be de-boxed, or another final action can be taken.

A change of weight might indicate theft, mislocation of one or more items, or other mishandling. By facilitating more convenient, more frequent, earlier, and more precise detection of those problems, the systems and methods described herein can enable a business to better respond to those problems, thereby lessening their impact on the business.

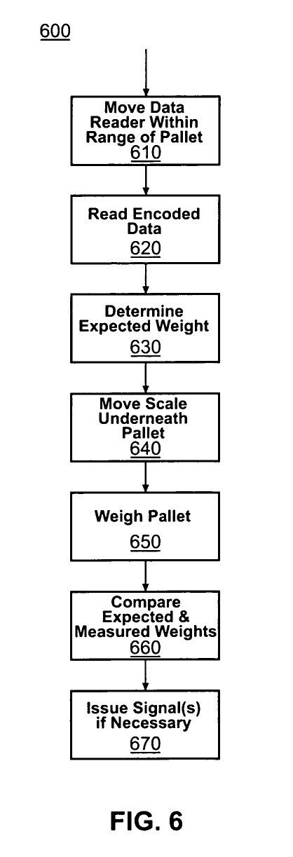

FIG. 6 is a flowchart of a method 600 according to one embodiment. The method 600 is performed at the destination location or other location at which an audit operation is needed. The method 600 will be described herein with reference to the devices and structures depicted in FIGS. 1-3, but it should be understood that the method 600 is not limited to practice with those devices and structures. For example, reference to a pallet in FIG. 6 and its following description is simply by way of example; the “pallet” could just as well be a crate, barrel, container of any type, item packaged or unpackaged, or collection of items.

To begin, the method 600 moves (step 610) the data reader 150 within a reading range (or volume) of the pallet 200. This moving step 610 may occur when the data reader 250 on the forklift 100 or other mobile platform in maneuvered within proximity of the pallet 200. Alternatively, the moving step 610 may occur when the pallet 200 is transported and placed within the reading range of a stationary data reader 150. Thus, the moving step may entail moving one or both of the data reader 150 and/or the pallet 200 such that the pallet 200 is within a reading range of the data reader 150. Once within range, the method reads (step 620) the encoded data on the pallet 200 or its loaded items. The data may be encoded in the RFID tags 240, in optical codes, or by other means. The data may be encoded on the pallet, container, or other carrier, or it may alternatively or additionally be on each item loaded on the pallet or the like. After reading the data, the method 600 determines (step 630) an expected weight for the pallet. The determining step 630 may be performed in various ways. For example, the data read in step 620 may comprise the expected weight. As another example, utilizing identification data read in step 620, the determining step 630 can look up a corresponding expected weight in either a local database or a database on a remote computer. In either case, an advantage of pallet-based encoding is that one read provides the data for the entire pallet. If the data is encoded at a finer level (e.g., item level), then the data reader 150 or the processor 310 may need to sum the multiple weights for each item to get a total weight for the collection.

The method 600 also moves (step 640) the scale 140 underneath the pallet 200. As with the moving step 610, the moving step 640 does not necessarily imply motion of the scale 140 with respect to a stationary pallet 200. For example, by using a stationary scale and by moving the pallet 200 onto the scale, the moving step 640 may also be accomplished. After the moving step 640, however accomplished, the method 600 weighs (step 650) the pallet and compares (step 660) the expected weight to the measured weight. The method 600 can then issue (step 670) one or more signals as necessary, such as if the measured weight and the expected weight deviate by more than a predetermined threshold. Such a threshold hold may be based on the precision of the scale 140 or business considerations (e.g., how much of a deviation constitutes a financially significant difference given the cost of responding to the alarm and the value of the item). Different items may have different thresholds, and threshold data may be stored in a database with other item data. The signal may be raised locally (e.g., at the forklift 100), remotely, or at both locations. The signal may be a message on a display screen, a light that turns on, a light that blinks, a sound, or any sort of alarm.

The steps of the method 600 may be performed in an order different from what is illustrated, or steps may be performed simultaneously. For example, simultaneously weighing and data reading may provide an efficient sequence. Performing those steps just before, after, or during movement or other necessary handling of the items may also efficiencies. The method 600 may perform other steps not illustrated, such as writing the newly measured weight on the RFID tag 240, storing the measured weight and other tracking data, etc.

The algorithms for operating the methods and systems illustrated and described herein can exist in a variety of forms both active and inactive. For example, they can exist as one or more software or firmware programs comprised of program instructions in source code, object code, executable code or other formats. Any of the above can be embodied on a computer-readable medium, which include storage devices and signals, in compressed or uncompressed form. Exemplary computer-readable storage devices include conventional computer system RAM (random access memory), ROM (read only memory), EPROM (erasable, programmable ROM), EEPROM (electrically erasable, programmable ROM), flash memory and magnetic or optical disks or tapes. Exemplary computer-readable signals, whether modulated using a carrier or not, are signals that a computer system hosting or running a computer program can be configured to access, including signals downloaded through the Internet or other networks. Concrete examples of the foregoing include distribution of software on a CD ROM or via Internet download. In a sense, the Internet itself, as an abstract entity, is a computer-readable medium. The same is true of computer networks in general.

The terms and descriptions used herein are set forth by way of illustration only and are not meant as limitations. Similarly, the embodiments described herein are set forth by way of illustration only and are not the only means of practicing the invention. Those skilled in the art will recognize that many variations can be made to the details of the above-described embodiments without departing from the underlying principles of the invention. The scope of the invention should therefore be determined only by the following claims (and their equivalents) in which all terms are to be understood in their broadest reasonable sense unless otherwise indicated.

1. A method comprising:
reading data encoded on a pallet loaded with bulk articles;
determining, based on the data, an expected weight of the pallet and bulk articles;
weighing the pallet and bulk articles, thereby generating a measured weight;
comparing the expected weight and the measured weight; and
conditionally issuing a signal if the expected weight and the measured weight differ by at least a threshold amount.

2. A method according to claim 1, wherein the data is encoded on the pallet in the form of an RFID tag, and the reading step comprises operating an RFID reader to interrogate the RFID tag.

3. A method according to claim 1, wherein the data is encoded on the pallet in the form of an optical code, and the reading step comprises optically scanning the optical code.

4. A method according to claim 1, wherein the data comprises the expected weight.

5. A method according to claim 1, wherein the data comprises an identifier of the pallet, and the determining step comprises using the identifier to look up the expected weight.

6. A method according to claim 5, wherein the determining step comprises accessing a remote database to determine the expected weight.

7. A method according to claim 5, wherein the determining step comprises accessing a local database to determine the expected weight.

8. A method comprising:
moving a data reader within a reading range of a container loaded with articles;
reading data encoded on the container by use of the data reader;
determining, based on the data, an expected weight of the container and articles;
moving a scale underneath the container;
weighing, by use of the scale, the container and bulk articles, thereby generating a measured weight;
comparing the expected weight and the measured weight; and
conditionally issuing a signal if the expected weight and the measured weight differ by at least a threshold amount.

9. A method according to claim 8, wherein the data is encoded on the container in the form of an RFID tag, and the reading step comprises operating an RFID reader to interrogate the tag.

10. A method according to claim 8, wherein the data is encoded on the container in the form of an optical code, and the reading step comprises optically scanning the optical code.

11. A method according to claim 8, wherein the data comprises the expected weight.

12. A method according to claim 8, wherein the data comprises an identifier of the container, and the determining step comprises using the identifier to look up the expected weight.

13. A method according to claim 12, wherein the determining step comprises accessing a remote database to determine the expected weight.

14. A method according to claim 12, wherein the determining step comprises accessing a local database to determine the expected weight.

15. A mobile device comprising:
a data reader capable of reading data encoded on an item within a reading zone, thereby generating read data, wherein the mobile device is positionable such that the item is within the reading zone;
a scale that generates measured weight data of an item placed on the scale, wherein the mobile device is positionable such that the item is on the scale;
an indicator; and
a processor connected to the data reader, the scale, and the indicator, the processor being configured to access the read data and the measured weight data, the processor further configured to determine based on the read data an expected weight of the item, to comparing the expected weight and the measured weight data, and to conditionally activating the indicator if the expected weight and the measured weight data differ by at least a threshold amount.

16. A mobile device according to claim 15, wherein the mobile device comprises a forklift.

17. A mobile device according to claim 16, wherein the forklift comprises a plurality of forks, and the scale is connected to the plurality of forks.

18. A mobile device according to claim 15, wherein the data reader comprises an RFID reader.

19. A mobile device according to claim 15, wherein the data reader comprises an optical code reader.

20. A mobile device according to claim 15, wherein the indicator comprises at least one of the group selected from a display, a light, and a speaker.

21. A device comprising:
a data reader capable of reading within a reading zone data encoded on a pallet loaded with bulk articles, thereby generating read data;
a scale that generates measured weight data of the pallet and any items loaded on the pallet when the pallet is placed on the scale;
an indicator; and
a processor connected to the data reader, the scale, and the indicator, the processor being configured to access the read data and the measured weight data, the processor further configured to determine based on the read data an expected weight of the pallet and its loaded items, to comparing the expected weight and the measured weight data, and to conditionally activating the indicator if the expected weight and the measured weight data differ by at least a threshold amount.

22. A device according to claim 21, wherein the data reader comprises an RFID reader.

23. A device according to claim 21, wherein the data reader comprises an optical code reader.

24. A device according to claim 21, wherein the indicator comprises at least one of the group selected from a display, a light, and a speaker.
